(19) United States
(12) Patent Application Publication
(10) Pub. No.: US 2014/0181128 A1
(43) Pub. Date: Jun. 26, 2014

(54) Systems and Methods for Processing Patient Data History

(71) Applicants: Daniel J. Riskin, Palo Alto, CA (US); Anand Shroff, San Carlos, CA (US)

(72) Inventors: Daniel J. Riskin, Palo Alto, CA (US); Anand Shroff, San Carlos, CA (US)

(21) Appl. No.: 14/003,790

(22) PCT Filed: Mar. 5, 2012
(86) PCT No.: PCT/US12/27767

§ 371 Date: Jan. 9, 2014

Related U.S. Application Data
(60) Provisional application No. 61/450,086, filed on Mar. 7, 2011.

(51) Int. Cl. G06F 17/30

(52) U.S. Cl. CPC G06F 17/30684
USPC 707/756; 707/776

(57) ABSTRACT

Described herein are systems and methods for processing data. In some embodiments, a system may include a natural language processing (NLP) engine configured to transform a data set into a plurality of concepts within a plurality of distinct contexts, an ontology configured to structure the plurality of concepts by annotating relationships between and creating aggregations of the concepts, and a data mining engine configured to process the relationships of the concepts and to identify associations and correlations in the data set. In some embodiments, the method may include the steps of receiving a data set, scanning the data set with a natural language processing (NLP) engine to identify a plurality of concepts within a plurality of distinct contexts, structuring the data set with an ontology by creating aggregations of the concepts and annotating relationships between the concepts, and identifying patterns in the relationships between the plurality of concepts.

### CROSS REFERENCE TO RELATED APPLICATIONS

This patent application claims priority to U.S. Patent Application No. 61/450,086, titled “SYSTEMS AND METHODS FOR PROCESSING PATIENT HISTORY DATA”, filed on Mar. 7, 2011 which is herein incorporated by reference.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD OF THE INVENTION

Described herein are systems and methods for processing unstructured data. In some embodiments, the systems and methods described herein may be utilized with electronic medical records including patient history data.

### BACKGROUND OF THE INVENTION

Information in healthcare is all around us and comes in many different forms. In medical record systems today, only about 20% of data is structured or machine readable. Information that is not structured or machine readable is ignored or unusable in conventional analytics systems. Current methods of data extraction are slow, expensive and ineffective. Conventionally, the data mined has come from insurance claims and administrative data with minimal use of clinical notes. These systems, currently using only a fraction of the data available however, have already been shown to reduce cost and improve outcomes. If systems and methods had the capability of using the knowledge incorporated within unstructured data, the benefit would be tremendous. By utilizing this knowledge, care could be improved and cost reduced through disease management, quality improvement, efficiency, research, comparative effectiveness, and other healthcare analytics powered by this data.

There is a need for systems and methods that are able to rapidly parse, combine, and interpret multiple structured and unstructured data sources. As an example, if a system were able to rapidly parse and decipher a complete patient record, that single representation could support multiple approaches in disease management and quality improvement. Multiple representations (e.g. multiple parsed and deciphered patient records) could support approaches in disease management, quality improvement, practice improvement, research, and/or comparative effectiveness. Multiple representations could be created from patient records within a medical practice or even within an entire patient population and could be used to better understand that practice or population. Currently, improving care within a practice, region, or population requires extensive human processing and custom algorithms to analyze manually processed data. Conventional, human processed and machine assisted systems simply cannot find the majority of hidden knowledge under the current deluge of information that is not structured or machine readable.

Beyond traditional care improvement and policy support, a fundamental transition in care practice is possible. Systems and methods are needed that may perform subset (or cohort) analyses on large data sets incorporating unstructured data, rather than relying exclusively on expensive, randomized trials which are generally not performed or powered for subpopulations. For example, the subpopulation of octogenarian women with diabetes and hypertension may not respond in the same way as the overall population does to a given hypertension medication. This critical knowledge of how these patients might respond to intervention is currently unavailable because of expense and difficulty of recruiting within a narrow cohort. Current medical practice addresses this lack of information by assuming that all individuals with hypertension respond similarly to a given intervention whether or not they are elderly, female, diabetic, and taking a potentially interacting medication. In a randomized trial for a given antihypertensive drug, perhaps only 10-20 patients might be octogenarian women with diabetes and hypertension and the study would not be powered to assess outcome differences for this group nor would potentially useful information be reported within this subset. Conventional systems and methods make subset analysis for most diseases and potentially interacting medications impractical, rarely performed, and almost never reported. The data for such a subset analysis do exist however within the unstructured content of massive electronic medical record stores. While only 10-20 patients may fit the description in the prior example within a small expensive randomized trial, a thousand times as many may exist within a regional population. These individuals are being seen regularly by physicians and having their interventions and outcomes recorded on each clinical or hospital visit. Systems and methods that could access this wealth of information (e.g. recorded interventions and outcomes) could address needs in subpopulations like the example above for quality of care, efficiency, research, comparative effectiveness, and other clinical support. Systems and methods are therefore needed to save money and lives by leveraging the processing power, massive data stores, and growing clinical knowledge to offer a more personalized, data driven, real time approach to healthcare.

Additionally, many challenges exist to understanding and acting on information contained within fragmented data stores, which mostly exist in unstructured format. As an example, one of the most prevalent rich data sources related to patient care is the physician's narrative note. The majority of these notes however, have no machine readable, structured content. The majority of notes within an electronic medical record system have machine readable medications and problem list, but little to no other interpretable content. The detail rich history of present illness, past medical history, assessment, and plan are largely left as narrative unstructured and unusable text. Thus, the clinical texts themselves contain information on diseases, interventions, and outcomes, but in a way that can only be utilized by a single physician or healthcare provider with a manual review at the point of care. The understanding of notational text documents is particularly difficult due to lack of punctuation and grammar, and frequent use of terse abbreviations and symbols. Some are ungrammatical and composed of short, telegraphic phrases, and with extensive shorthand (abbreviations, acronyms, and local dialectal shorthand phrases). These shorthand lexical units are often overloaded (i.e., the same set of letters has multiple renderings). Additionally, concepts are referenced in multiple ways and related concepts are often only obvious to the skilled provider with extensive training and upon manual review. As an example, hypertension in a patient could be referenced using multiple terms such as high blood pressure, essential hypertension, and systolic BP 170—all related to hypertension. Furthermore, antihypertensive medications such as atenolol, metoprolol, and lisinopril all impact hypertension. Currently, even with sophisticated natural processing systems, concepts can be understood, but tying together concepts to understand interactions and actionable interventions is rarely feasible.

Thus, there is a need in the field of processing data, and more specifically the field of processing electronic medical records including patient history data, for new and improved systems and methods for processing data, particularly systems and methods that are able to rapidly parse, combine, and interpret multiple structured and unstructured data sources. Described herein are devices, systems and methods that address the problems and meet the identified needs described above.

### SUMMARY OF THE DISCLOSURE

Described herein are systems and methods for processing data. In general, the systems described herein may include a natural language processing (NLP) engine configured to transform a data set into a plurality of concepts within a plurality of distinct contexts, an ontology configured to structure the plurality of concepts by annotating relationships between and creating aggregations of the concepts, and a data mining engine configured to process the relationships of the concepts and to identify associations and correlations in the data set. In general, the methods described herein may include the steps of receiving a data set, scanning the data set with a natural language processing (NLP) engine to identify a plurality of concepts within a plurality of distinct contexts, structuring the data set with an ontology by creating aggregations of the concepts and annotating relationships between the concepts, and identifying patterns in the relationships between the plurality of concepts.

In some embodiments, a system for processing data may include a natural language processing (NLP) engine configured to receive a data set and to transform the data set into a plurality of concepts within a plurality of distinct contexts, an ontology configured to structure the plurality of concepts by annotating relationships between the concepts and creating aggregations of the concepts, and a data mining engine configured to process the relationships between the plurality of concepts and the aggregations of the plurality of concepts and to identify associations and correlations in the data set. In some embodiments, the data set includes at least one physician encounter note. The encounter note may be, for example, a History and Physical (H&P) note or a Subjective, Objective, Assessment, and Plan (SOAP) note. In some embodiments, the plurality of distinct contexts are medical contexts. The medical contexts may include, for example, history of present illness, past medical history, past surgical history, allergies to medications, current medications, relevant family history, and social history. The associated annotations may include ontologic concepts. The associated annotations may include temporal context.

In some embodiments, a system for processing patient history data may include a natural language processing (NLP) engine configured to receive a data set and identify a plurality of concepts within the data set, a concept recognition tool coupled to the NLP engine configured to recognize the plurality of concepts within a plurality of distinct contexts and to derive a list of features that represent the data set, an ontology configured to structure the data set by aggregating features, a data mining engine configured to process the list of features to identify associations and correlations in the data set, an interface configured to receive queries about the data set and to return corresponding associations and correlations identified in the data set.

In some embodiments, the natural language processing (NLP) engine is configured to receive a data set and to transform the data set into a plurality of concepts within a plurality of distinct contexts. In some embodiments, the concepts are noun phrases recognizable by the NLP engine. In some embodiments, the NLP engine is configured to scan the data set and to use concepts in the data set to transform the data set into a plurality of concepts within a plurality of distinct contexts. Alternatively, in some embodiments, the NLP engine is configured to employ an algorithm to scan the data set and to apply syntactic and semantic rules to the data set to transform the data set into a plurality of concepts within a plurality of distinct contexts.

In some embodiments, the concept recognition tool, coupled to the NLP engine, is configured to recognize the plurality of concepts within a plurality of distinct contexts and to derive a list of features that represent the data set.

In some embodiments, the concept recognition tool further includes a dictionary having a list of terms. In some embodiments, the list of terms may include concept names and synonyms for those concepts. In some embodiments, the concept recognition tool is further configured to match the plurality of concepts against the list of terms and to recognize concepts and generate annotations.

In some embodiments, the ontology is configured to structure the plurality of concepts by annotating relationships between the concepts and creating aggregations of the concepts.

In some embodiments, the ontology is configured to structure the data set by aggregating features derived by the concept recognizer. Alternatively, in some embodiments, when the concept recognition tool is further configured to match the plurality of concepts against the list of terms and to recognize concepts and generate annotations, the ontology is further configured to create additional annotations.

In some embodiments, the data mining engine is configured to process the relationships between the plurality of concepts and the aggregations of the plurality of concepts and to identify associations and correlations in the data set.

In some embodiments, a data mining engine is configured to process the list of features derived by the concept recognizer to identify associations and correlations in the data set.

In some embodiments, the data mining engine is further configured to build a predictive model from the data set.

In some embodiments, the data mining engine is further configured to summarize large patient cohorts from the list of features.

In some embodiments, the data mining engine is further configured to cluster data with respect to an outcome and identify paths through the list of features that lead to that outcome.

In some embodiments, the interface is configured to receive queries about the data set and to return corresponding associations and correlations identified in the data set. In some embodiments, when the data mining engine is further configured to build a predictive model from the data set, the interface may be further configured to receive queries about the data set and to return information determined by the predictive model.

In some embodiments, a system for processing patient history data may further include an input component configured to read in a data set from a database. In some embodiments, the input component may be a wrapper. A wrapper may be a program or script configured to prepare for and make possible the running of the remaining components of the system, i.e. the NLP engine, the ontology, etc. In some embodiments, the wrapper may include data that is put in front of or around a transmission (i.e. the transmission of the data set) and provides information about the data set. Alternatively, in some embodiments, the input component may be a data adaptor or input module. In some embodiments, the input component is configured to read in a data set from a database such as a hospital database or electronic medical records database, for example. In some embodiments, a system for processing patient history data may further include an indexing engine configured to search the data set.

In general, a method for processing data includes the steps of receiving a data set, scanning the data set with a natural language processing (NLP) engine to identify a plurality of concepts within a plurality of distinct contexts, structuring the data set with an ontology by creating aggregations of the concepts and annotating relationships between the concepts, identifying patterns in the relationships between the plurality of concepts. In some embodiments, the method may further include the step of storing the concepts, relationships, and aggregations as a digital representation of the patient. In some embodiments, a method for processing patient history data may include the steps of receiving a plurality of historical information for a patient, scanning the plurality of historical information with a natural language processing (NLP) engine to identify a plurality of concepts within a plurality of distinct contexts, structuring the plurality of historical information with an ontology by annotating relationships between the concepts and creating aggregations of the concepts, and transforming the plurality of historical information for a patient into a digital representation of the patient that includes the concepts, relationships, and aggregations.

In some embodiments, the step of receiving a plurality of historical information further includes receiving a plurality of medical records or notes for a patient.

In some embodiments, the step of receiving a plurality of historical information further includes receiving a plurality of historical information for a population of patients.

In some embodiments, the step of transforming the plurality of historical information for a patient into a digital representation of the patient further includes transforming the plurality of historical information for a population of patients into a digital representation of the patient population.

In some embodiments, the method may further include the step of comparing the digital representations of a first patient to the digital representations of a second patient. In some embodiments, the digital representations may be compared through cohort analysis. A cohort may be defined generally as a group of subjects who have shared a particular experience during a particular time span. In some embodiments, a cohort may be a group of people, or patients, having approximately the same age. Alternatively, a cohort may be a group of people that share a specific patient outcome, a group of people that have received similar care prior to the specific patient outcome, a group of people that share a specific disease, and/or a group of people that share any other suitable quality or experience.

In some embodiments, a cohort may represent group of people that share a specific patient outcome or result. In this embodiment, differing cohorts may have received different care prior to the outcome. A cohort analysis may be performed in order to evaluate differential results based on differential intervention.

In some embodiments, a cohort may represent group of people that share a specific disease state. In this embodiment, differing cohorts may have different outcome based on the same or differing interventions. A cohort analysis may be performed in order to evaluate differential results within a disease state based on differential intervention.

In some embodiments, a cohort may represent group of people that have experienced hospital readmission or another specific undesirable outcome. In this embodiment, differing cohorts may have different outcomes based on the same or differing interventions. A cohort analysis may be performed in order to evaluate differential undesirable outcome results based on differential intervention.

In some embodiments, a cohort may represent group of people that have experienced an adverse event. In this embodiment, differing cohorts may have different outcomes based on medication or other intervention applied. A cohort analysis may be performed in order to evaluate differential adverse event rates based on differential intervention.

In some embodiments, a cohort may represent group of people that have experienced a specific payer response to billing. In this embodiment, differing cohorts may have different outcomes based on submission pattern. A cohort analysis may be performed in order to evaluate payer response based on differential submission pattern.

In some embodiments, a method for processing patient history data may include the steps of receiving a data set and identifying a plurality of concepts within the data set with a natural language processing (NLP) engine, recognizing the plurality of concepts within a plurality of distinct contexts and deriving a list of features that represent the data set with a concept recognition tool, structuring the data set by aggregating features with an ontology, processing the list of features and identifying associations and correlations in the data set with a data mining engine, and receiving queries about the data set and to returning corresponding associations and correlations identified in the data set.

In some embodiments, recognizing the plurality of concepts further includes matching the plurality of concepts against a list of dictionary terms and recognizing concepts and generating annotations. In some embodiments, structuring the data set further includes creating additional annotations with the ontology. In some embodiments, the method further includes the step of scoring the annotations.

### BRIEF DESCRIPTION OF THE DRAWINGS

FIGS. 1-3 illustrate exemplary embodiments of systems and methods for processing data.

FIG. 4 illustrates a Screenshot of simulated note for a patient with heart failure.

FIG. 5 illustrates a Heart Failure Core Measure Application for the systems and methods described herein.

### DETAILED DESCRIPTION OF THE INVENTION

Described herein are systems and methods for processing data. In some embodiments, the systems and methods described herein may be utilized with electronic medical records including patient history data.

Healthcare applications are only as good as the data that drives them. Information in healthcare is all around us and comes in many different forms. However, the majority of applications in the market today cannot access the data they need. Current methods of data extraction are slow, expensive and ineffective. These current methods include mining insurance claims and administrative data with minimal use of clinical notes. In modern medical record systems less than 10% of data is structured or machine readable. The systems and methods described herein allow unstructured content to be meaningfully accessed and analyzed.

The systems and methods described herein extract data in new and unique ways. In some embodiments, the systems and methods described herein automate the conventional manual coding performed by the physician, resulting in easier documentation (e.g. charting). In some embodiments, the systems and methods described herein also perform an automated extraction of data from original documents including unstructured clinical text. In some embodiments, this data is extracted while coding to an ontology, such as SNOMED. This data collection may be faster and more efficient saving time and money. The systems and methods described herein may include a clinical natural language processing (NLP) platform that enables medical practitioners and administrators to effectively make use of the wealth of currently unusable medical information they collect. The systems and methods described herein may be coupled to or partnered with applications (end-user applications) on top of the robust data layer.

The extracted data may provide a robust data layer able to power applications. In particular to power healthcare applications to address quality, billing, clinical research, and challenges inherent in meaningful use, accountable care organization, and ICD-10 conversion. The extracted data may also provide insight into previously unusable unstructured content.

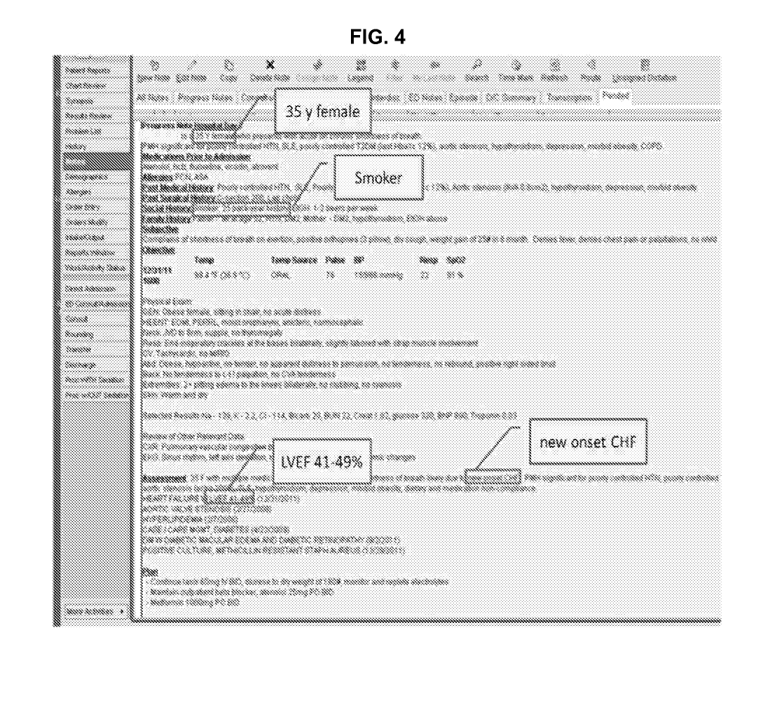

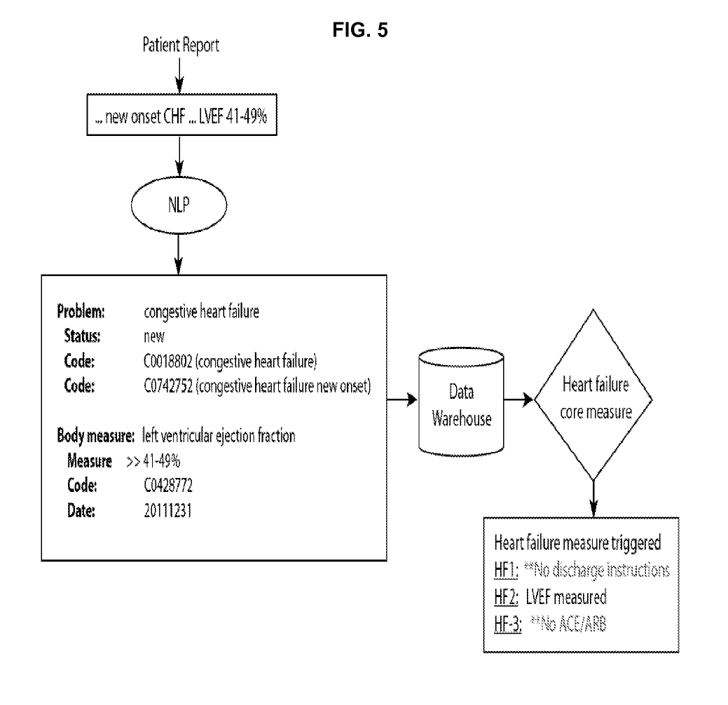

In some embodiments, a Natural Language Processing (NLP) engine identifies concepts and offers context, ontologies provide relationships between the concepts, and a data mining engine provides the engine to make sense of patterns. The data mining engine may process vast quantities of data. For example, an entire historical chart may be processed in seconds and analyzed for critical patterns. In some embodiments, the systems and methods described herein may incorporate rigorous security protocols, auditing, and modern application programming interfaces. In some embodiments, the system may have a modular design comprising knowledge components and processing engines. In some embodiments, the systems and methods may include a parser, which determines the structure of a sentence. For example, for each sentence, the system and method may generate a set of structured findings, such as problems (congestive heart failure), medications (ACEI), or procedures (cervical screening) along with associated modifiers, such as certainty (no, high certainty), status (previous, new), body location (lung), and section (Assessment). In some embodiments, the systems and methods may also include an encoder, which determines appropriate codes for the parsed output based on the coding table. Two examples of structured output for text (new onset of CHF and LVEF 41-49%) selected from the screenshot of a simulated note (FIG. 4) are shown in FIG. 5. Once the output is generated, it may be stored in a structured data warehouse, which can be subsequently queried to obtain fine-grained data required by a clinical application.

The systems and methods described herein may allow for an understanding of language and allow for extracting of codified content from text. In healthcare for example, the systems and methods described herein may provide for the extraction of meaning from clinical text. In some embodiments, the systems and methods may understand negation, combine concepts and modifiers to achieve granularity, and handle complex syntax.

In some embodiments, the systems and methods described herein may further include a search tool. In some embodiments, the search tool may allow complex searches on semi-structured databases along ontologic modules. As an example, a user may need to find patients with heart failure. The user can generate a search along the SNOMED-based heart failure ontologic module (as described in detail below), including congestive heart failure, dilative cardiomyopathy, restrictive cardiomyopathy, and related diseases. The search tool may form the core for building logic around measure extraction and reporting required by a healthcare system or provider (e.g. a hospital), for example.

The systems and methods described herein may process source data, such as narrative notes, into key components. For example, a physician's narrative note may read “History of Present Illness (HPI): This is a 78 year old woman with a history of coronary disease and diabetes, who presents complaining of shortness of breath. The patient described chest tightness, fever, dyspnea, nausea, and epigastric pain.” With Natural Language Processing (NLP), conceptconcepts may be understood in context. Languages, or ontologies, may be used to further structure the data into usable information and to create relationships between words. For example, the conceptconcepts of “78 year old woman”, “coronary disease”, “diabetes”, “shortness of breath”, “chest tightness”, “fever”, “dyspnea”, “nausea”, and “epigastric pain” may be identified by the NLP engine. Information regarding temporal relationship or other context may further be provided by the NLP engine. These concepts may be further grouped or tagged. For example, “shortness of breath” may be tagged as a current complaint (CC); “coronary disease” and “diabetes” may be tagged as past medical history (PMH); and “chest tightness”, “fever”, “dyspnea”, “nausea”, and “epigastric pain” may be tagged as history of present illness (HPI). The ontology or ontologies may be used to create relationships between these concepts. For example, “fever”, “nausea”, and “epigastric pain” may be linked or grouped, while “coronary disease”, “chest tightness”, and “dyspnea” may also be linked or grouped. Multiple layers of relationships can be created, and these patterns may suggest useful information. For example, “dyspnea” and “fever” may be linked or grouped creating an additional layer of relationships.

In some embodiments, the systems and methods described herein may be used in clinical decision support. As described above, in the referenced case of dyspnea and chest tightness, the historical chart may include that the patient is a smoker and therefore a diagnosis of COPD may become more obvious. In some embodiments, a system can be designed to recognize potential problems with a patient before they occur. In this example, the risk to the patient of COPD may have been identified early and smoking cessation may have been suggested for them. In some embodiments, a system can be designed to support clinical decisions. Although a diagnosis of COPD may be likely, a diagnosis of angina may be possible and more concerning based on the relevant information. The patient may thus be tested for coronary artery disease early, catching an unlikely but extremely concerning possibility.

In some embodiments, the systems and methods described herein may be used in disease management. Disease management tools using available data may be able to reduce cost and improve outcomes. As described herein, the systems and methods may be able to rapidly parse and decipher a complete patient record. When a patient's history is fully mapped by a computer, that single representation can support multiple approaches in disease management and quality improvement. In the example of dyspnea, chest tightness, and smoking, historical data may reveal previous treatment for COPD, including interventions that were effective for this given patient and those that were not. A customized pathway of care may be developed based on knowledge gained from the historical record such as previous good outcome using a nicotine patch for this patient or episodes of readmission related to air quality which might suggest more aggressive follow up during these periods.

In some embodiments, the systems and methods described herein may be used to find needs and relationships within a practice, moving beyond a single patient. A human processed system typically cannot find hidden knowledge under a deluge of information, but a properly set up, data driven system can. Moving beyond a practice, in some embodiments, the systems and methods described herein may be used to understand an entire population. At the local, regional, or national population level, care can be improved and cost reduced through quality improvement, efficiency, research and comparative effectiveness. While existing, conventional systems use less than 10% of available data, the systems and methods described herein may capture up to and including 100% of the data, using Natural Language Processing (NLP) and ontologies to structure context and relationships for machine learning. What used to take years, such as determining whether a drug or device intervention worked for a patient population, can now be done in minutes with the systems and methods described herein. Furthermore, subset (or cohort) analysis which was previously impossible in moderately sized, expensive, randomized trials is possible with the systems and methods described herein based on the large data set available. For example, octogenarian women with diabetes and hypertension may not respond in the same way to a given hypertension medication as the overall population does. This critical knowledge is currently unavailable given that the only source of knowledge related to this population would need to be gained from randomized trials on a given antihypertensive drug, in which perhaps 10-20 patients were octogenarian women with diabetes and hypertension and they were not specifically randomized between different antihypertensive medications. Real time determination of effectiveness of an intervention within a population or subpopulation, what used to be impossible, may be realized by the systems and methods described herein. The systems and methods described herein may save money and lives by leveraging the processing power, massive data stores, and growing clinical knowledge to offer a more personalized, data driven, real time approach to healthcare.

In some embodiments, the systems and methods described herein may be used in cohort analysis for quality improvement. One example of cohort analysis for quality improvement is hospital readmission. For example, the diabetic hypertensive octogenarian patient referenced above represents a subset of patients that has never been independently studied because of the great expense associated with randomized trial and the difficulty performing such a trial in rare patient cohorts. By using data captured in the narrative record, utilizing NLP and ontologies to map the patient history, combining histories of multiple patients, and comparing cohorts with similar characteristics, useful knowledge can be identified. After an admission for diabetic ketoacidosis, this patient may stay in the hospital several days and be discharged home. Within a given population, it may be found that this population subset, after discharge for diabetic ketoacidosis, has an extremely high hospital readmission rate within the subsequent 3 months for coronary disease. This would suggest that aggressive outpatient management of the associated condition may reduce the potential coronary complication or event and reduce the likelihood of readmission. Such actionable cohort analysis can be seen to improve outcomes and reduce healthcare costs.

In some embodiments, the systems and methods described herein may be used for studying or analyzing revenue capture. One example of revenue capture is cohort analysis of a patient population with specific demographics and diagnoses evaluated using health plan reimbursement rejections. By utilizing the patient subset determined by NLP and ontologic processing of current and historical unstructured information, a likely rejection candidate may be identified. By creating a cohort of patients with matching demographics and diagnoses and using non-rejection as an outcome measure, the characteristics of submitted claims that lead to non-rejection may be identified.

In some embodiments, the systems and methods described herein may be used for studying or analyzing adverse events. One example of adverse events is evaluating patient outcomes related to medication use within a given patient subset or region. Utilizing unstructured processed historical and current patient information may identify subsets of patients that have higher or lower adverse event rates. As an example, it may be possible that diabetic men in their fifth decade of life have a high rate of hypoglycemia when using a specific anti-diabetes medication. By bringing in narrative content from notes, unstructured data incorporated in the hospital electronic medical record related to laboratory values, context identified through NLP, concepts matched via ontology, and data mining on top of ontologic concepts, clear patterns related to glucose levels in this subpopulation can be identified and a potentially harmful drug in a specific patient population may be recognized.

In some embodiments, the systems and methods described herein may be used for the identification of patients likely to be high-risk in the future. The identification of these patients may enable targeted health promotion programs that can improve these patients' health and reduce direct costs as well as indirect costs to employers through loss of productivity, as these patients account for a large percentage of future healthcare expenditures. This intervention will lead to improved outcomes, shorter hospitalizations, and reduced direct medical costs. The systems and methods described herein may provide advanced decision-support tools including the ability to review in real time the patient database for patients with similar characteristics, the manners in which these patients were treated, the complications they experienced, and the outcomes of interventions. Data extracted by the systems and methods described herein may provide a unique opportunity to query a hospital for patients with similar conditions, and to discover real-world clinical evidence advising optimal care. The systems and methods described herein may have the capacity to repurpose informational byproducts of routine clinical documentation, acquiring usable data at an order of magnitude lower cost than otherwise possible. Data may be extracted from historical electronic medical records to discover clinical correlates of utilization of healthcare and thereby predict high-utilization patients. The systems and methods described herein may create models with improved predictive capabilities. In this example, the systems and methods described herein may be used to build and implement a fully structured data repository and use queries of this repository to bring evidence derived from clinical documentation to real-time treatment decisions. A search tool, as described herein, may allow for sophisticated matching of patient characteristics to the records of other patients in the database.

As a specific example, consider a case of a 13 year old girl with disease complications such that her physicians were unable to find relevant studies pertaining to the management of her unique medical situation. The girl had systemic lupus erythematosus (SLE). Her presentation was complicated by nephrotic range proteinuria, antiphospholipid antibodies (APL), and pancreatitis. Although anticoagulation is not standard practice for children with SLE, even when critically ill, these additional factors potentially put the patient at risk for thrombosis and her physicians considered anticoagulation. However, they were unable to find relevant studies in the patient's situation; they were reluctant to place the patient on anticoagulation, given the risks of bleeding. A survey of colleagues failed to find consensus. A fully structured data repository as described above and queries of this repository may be used to bring evidence derived from clinical documentation to the real-time treatment decisions for this specific patient. A query of such a system may have provided a better understanding of her risk of thrombosis and guided a decision to anticoagulate her within 24 hours of admission. The systems and methods described herein may expedite access to structured clinical data that can inform treatment decisions at the point of care and in real time.

In some embodiments, the systems and methods described herein may allow for the conversion of text strings describing patient characteristics to fixed concepts by taking advantages of the structured descriptions of medical knowledge encoded in SNOMED CT and the Unified Medical Language System (UMLS), for example. In some embodiments, patient records may first be processed to convert the structured and free text documents into SNOMED CT and UMLS codes, for example. Thus, the patient description (from the case you are trying to provide advice) and the existing patient records can be matched in terms of structured clinical Unified Medical Language System codes, not text strings. This allows the match between patient description and database to be made on a conceptual or semantic level rather than by matching words as you see in typical database searches. In some embodiments, negation may also be addressed. For example, the phrase “no evidence of” a particular sign or disease state. In some embodiments, ontologically based inference may also be supported. For example, knowing that in seeking patients with pancreatitis, you may want to look for related concepts such as “lipase,” a common laboratory test used to test for pancreatitis.

In some alternative embodiments, the systems and methods described herein may be used for providing a robust data layer to enable healthcare analytics systems, specifically systems that enable measurement and compliance with performance metrics. Conventionally, many organizations design performance measures that reflect the principles of improving health, improving healthcare, and reducing cost. The metrics most broadly adopted include the Centers for Medicare and Medicaid Services (CMS) and Joint Commission Core Measures Set, which will transition to “Accountability Measures” in 2013, and the National Committee on Quality Assurance's (NCQA) Health Effectiveness Data and Information Set (HEDIS), which has been adopted by over 90% of U.S. Health plans. These metrics are intended to drive towards the three-part aim of better health, better healthcare, and reduced costs. Currently however, the performance of these metrics has come under a great deal of scrutiny because the very data upon which they are generally founded (insurance claims and administrative data, for example, which are sparse, often inaccurate, lack granularity, and are often absent from diagnoses) were never intended for use in quality assessment. Therefore, the utility of the performance metrics themselves is limited by inadequacy of source data collected by conventional methods.

In the particular example of HEDIS and Core Measures, which are intended to function both as measurement and quality improvement tools, both are derived from administrative data which are not derived in real-time—when clinical actions can actually impact patient care and outcomes. Conventionally, HEDIS performance is reported once yearly—with medical facilities commonly learning of results only after they are publically disseminated, and Core Measures are reported no more than quarterly, generating a lag between results and implementation of clinical action. Furthermore, the conventional collection of these measures is time and labor intensive.

In addition, the conventional use of claims data in a clinical context notoriously causes “coding creep” in which payments increase over time, causes difficulty in identifying incident versus prevalent disease cases, and results in a lack of data which would indicate the underlying reason for service and the outcome. The inadequacy of current coding paradigms for accurately describing and capturing ambulatory care sensitive conditions can be resolved with more granular data captured from clinical progress notes as described by the systems and methods described herein. The systems and methods described herein may provide a real-time solution based on highly granular clinical data offers the opportunity to reduce the current clinical and financial sequelae of performance measures. Specifically, in some embodiments, the systems and methods may automate the queries of all clinical outpatient notes to generate real-time capture of performance measures for patients (e.g. HEDIS for outpatients and a subset of core measure fallouts for inpatients). Text reports, or narratives, in Electronic Medical Records (EMR) encompass rich, diverse, and abundant sources of information that is relevant to healthcare. The systems and methods described herein transform huge amounts of narrative data into coded form usable, for example, for quality improvement processes. In some embodiments, to obtain Core Measure metrics and HEDIS performance measures, for example, textual clinical reports may be processed (see FIG. 4, as described below), and the data stored into a structured data warehouse, which may be queried using a query tools to obtain the quality measures as described about. In this example, if the text report is obtained in real-time, the population reporting will also be in real-time, enabling interventions that can improve the process of care. Once the coded output is stored in the data warehouse, it can be used by any clinical applications capable of using standards compliant structured content.

FIG. 4 illustrates a screen shot of a simulated note for a 35 year old female patient, which documents that the patient has heart failure and other comorbidities. In this example, the note is a progress note, which contains relevant textual information (highlighted to facilitate readability) for the Heart Failure (HF) Core Measure metrics, which if not captured could trigger a fallout (or missed process measure). Conventional claims data may not capture such data. Since the information is in text, it cannot be used for the Core Measures without the use of the systems and methods described herein. However, once the data is processed as described herein, the information is in appropriate form. Thus, the processing of text as described herein can demonstrate emerging fallouts before the patient is discharged, enabling real time clinical correction to avoid missed process measures. In some embodiments, the output is stored in a data warehouse, and a search tool will be used to query the warehouse to search for specific metrics, for example, the Heart Failure (HF) Core Measure metrics. The search tool may provide for determining the patients for whom the CHF Core Measure are applicable and then will perform additional queries to obtain the metrics.

FIG. 5 illustrates an overview of a process for deriving the HF Core Measure after the report is processed and the output is stored in a structured data warehouse. FIG. 5 shows text that is relevant to the metrics associated with the measure and simplified output generated by the system as described herein for the two phrases “new onset of CHF” and “LVEF 41-49%”. CHF is shown as a problem “congestive heart failure” with a status modifier “new,” which represents temporal information, and two code modifiers corresponding to congestive heart failure and congestive heart failure new onset. Both codes are correct but the latter is more specific, or granular, than the former. In addition, a measure, “left ventricular ejection fraction” is shown with several modifiers: the measure value 41-49%, the date 20111231, which is the normalized date that the measure was taken, and a standard code.

In some embodiments, advantages of such a system and method may include the ability to compute a measure as soon as a clinical note or chart is generated; the ability to perform an intervention when the a clinical note or chart is processed before patient discharge—in some cases improving the process of care; the output is precise, accessible, and in a standardized form that can be used for multiple other applications aimed at improving healthcare and reducing costs; and measures can be computed retrospectively for previous years to compare and quantify changes in the health care process. The systems and methods described herein may enable real-time feedback regarding clinical performance on Core Measures and HEDIS metrics, for example, that will facilitate timely transformation into clinical practice. In some embodiments, this makes the feedback cycle to the clinician substantially more realistic and timely, while not requiring the workforce to change their workflow charting habits.

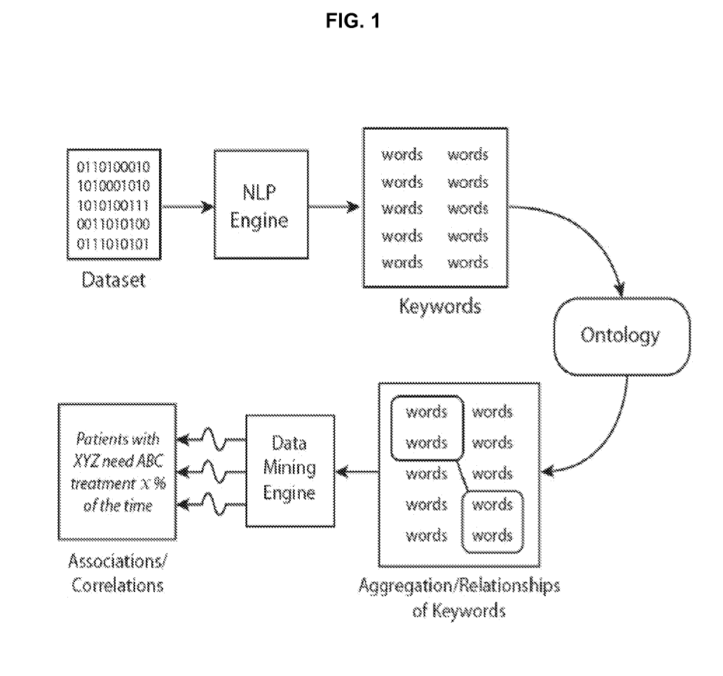

FIGS. 1-3 illustrate exemplary embodiments of systems and methods for processing data. As shown in FIG. 1, in some embodiments, a system for processing data may include a natural language processing (NLP) engine configured to receive a data set and to transform the data set into a plurality of concepts within a plurality of distinct contexts, an ontology configured to structure the plurality of concepts by annotating relationships between the concepts and creating aggregations of the concepts, and a data mining engine configured to process the relationships between the plurality of concepts and the aggregations of the plurality of concepts and to identify associations and correlations in the data set. In some embodiments, the data set includes at least one physician encounter note. The encounter note may be, for example, a History and Physical (H&P) note or a Subjective, Objective, Assessment, and Plan (SOAP) note. In some embodiments, the plurality of distinct contexts are medical contexts. The medical contexts may include, for example, history of present illness, past medical history, past surgical history, allergies to medications, current medications, relevant family history, and social history.

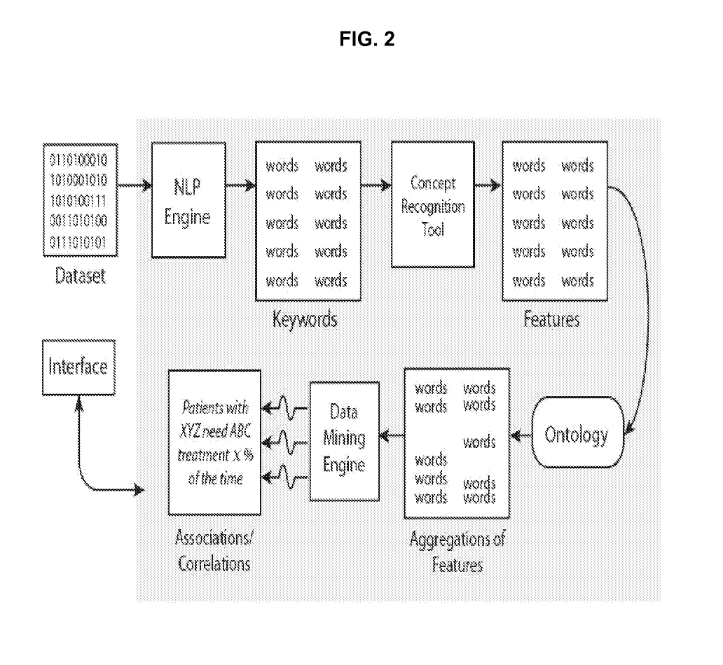

In some embodiments, as shown in FIG. 2, a system for processing patient history data may include a natural language processing (NLP) engine configured to receive a data set and identify a plurality of concepts within the data set, a concept recognition tool coupled to the NLP engine configured to recognize the plurality of concepts within a plurality of distinct contexts and to derive a list of features that represent the data set, an ontology configured to structure the data set by aggregating features, a data mining engine configured to process the list of features to identify associations and correlations in the data set, an interface configured to receive queries about the data set and to return corresponding associations and correlations identified in the data set.

As shown in FIGS. 1 and 2, the natural language processing (NLP) engine is configured to receive a data set and to transform the data set into a plurality of concepts within a plurality of distinct contexts. In some embodiments, the concepts are noun phrases recognizable by the NLP engine. In some embodiments, the NLP engine is configured to scan the data set and to use concepts in the data set to transform the data set into a plurality of concepts within a plurality of distinct contexts. Alternatively, in some embodiments, the NLP engine is configured to employ an algorithm to scan the data set and to apply syntactic and semantic rules to the data set to transform the data set into a plurality of concepts within a plurality of distinct contexts.

In some embodiments, the NLP engine may transform the data set into machine-interpretable structured data by associating tags with specific concepts—for instance labeling the word “hypertension” within a past medical history section. In some embodiments, the NLP engine employs algorithms to scan unstructured text, apply syntactic and semantic rules to extract computer-understandable information, and create a targeted, standardized representation. Alternatively, the NLP engine may simply scan the text for concepts (e.g. hypertension) and associate a tag with the word (e.g. “past medical history”). For example, the NLP engine may be configured to scan the text to identify concepts in the text.

In some embodiments, the NLP engine recognizes semantic metadata (concepts, their modifiers, and the relationships between them) in the data set and maps the semantic metadata to a relevant coded medical vocabulary. This allows data to be used in any system where coded data is required. This can include reasoning-based clinical decision support systems, computer-assisted billing and medical claims, and automated reporting for meaningful use, quality, and efficiency improvement. In some embodiments, the structured data may be formatted in one of a Clinical Document Architecture (CDA), a Continuity of Care Record (CCR), and a Continuity of Care Document (CCD) format. The structured data is configured to be compatible with at least one of health information exchanges (HIES), Electronic Medical Records (EMRs), and personal medical records.

In some embodiments, the NLP engine may perform some pre-processing functions. Those functions may include any combination of spell-checking, document structure analysis, sentence splitting, tokenization, word sense disambiguation, part-of-speech tagging, and/or parsing. In some embodiments, contextual features including negation, temporality, and event subject identification may be utilized in an interpretation of the data set. In some embodiments, the NLP engine may include a combination of the following components: tokenizer, sentence boundary detector, part-of-speech tagger, morphological analyzer, shallow parser, deep parser (optional), gazetteer, named entity recognizer, discourse module, template extractor, and template combiner.

The NLP engine may use one of several different methods (or a combination thereof) to extract information and transform the data set into a plurality of concepts within a plurality of distinct contexts. These methods may include methods such as pattern matching or more complete processing methods based on symbolic information and rules or based on statistical methods and machine learning. In some embodiments, as described herein, the information can be used for decision support and to enrich the data set (e.g. EMR) itself.

In some embodiments, pattern matching exploits basic patterns over a variety of structures—text strings, part-of-speech tags, semantic pairs, and dictionary entries. Alternatively the NLP engine may use shallow and full syntactic parsing. In some embodiments, as described in more detail below, ontology-driven natural language processing aims at using an ontology to guide the processing of the data set. Syntactic and semantic parsing approaches may combine the two in one processing step.

When extracting information from the data set, such as narrative text documents, the context of the concepts extracted may play an important role in some embodiments. In some embodiments, this contextual information may include negation (e.g. “denies any abdominal pain”), temporality (e.g. “ . . . appendectomy 2 years ago . . . ”), and the event subject identification (e.g. “his mother has diabetes”). In some embodiments, contextual features may include Validity (valid/invalid), Certainty (absolute, high, moderate, low), Directionality (affirmed, negated, resolved), and Temporality (recent, during visit, historical). In some embodiments, contextual information or features may include modifiers such as body location, laterality (e.g. left-handedness, right-footedness), direction (e.g. caudal, cephalad, etc.), or any other suitable modifier. Alternatively, the system may identity any other suitable contextual feature, metadata, or annotation, of which there are many.

Algorithms combining the analysis of the subject of the text (e.g., the patient) and other contextual features may be utilized by the NLP engine and/or the concept recognizer as described below. In some embodiments an algorithm may determine the values of any of the contextual features described above. In some embodiments, the algorithm may determine at least these contextual features: Negation (negated, affirmed), Temporality (historical, recent, hypothetical), and Experiencer (patient, other). In some embodiments, the algorithm may use regular expressions to detect trigger terms, pseudo-trigger terms, and scope termination terms, and then attributes the detected context to concepts between the trigger terms and the end of the sentence or a scope termination term.

In some embodiments, the NLP engine is a Medical Language Extraction and Encoding System (MedLEE). In some embodiments, MedLEE will extract, structure, and encode clinical information in textual patient reports or charts so that the data can be used by subsequent automated processes. MedLEE may then translate the information to terms in a controlled vocabulary, such as the UMLS or SNOMED. MedLEE may read textual reports, translate the information to terms in a controlled vocabulary, and generate structured information. MedLEE extracts clinical information from patient documents, and encodes the information in a form that is highly granular, rendering the information into a representation that is precise and that can be accurately accessed for different applications. In some embodiments, it may be possible to make granular distinctions between patient cases and thereby retrieve clinical scenarios with high specificity. For example, MedLEE may enable retrieving cases where the patient may have pneumonia currently, while distinguishing and filtering out other mentions of pneumonia (e.g. family history of pneumonia, pneumonia in certain locations in the lung, certain types of pneumonia, or workup for pneumonia).

As shown in FIG. 2, the concept recognition tool, coupled to the NLP engine, is configured to recognize the plurality of concepts within a plurality of distinct contexts and to derive a list of features that represent the data set. In some embodiments, the concept recognition tool further includes a dictionary having a list of terms. In some embodiments, the list of terms may include concept names and synonyms for those concepts. In some embodiments, the concept recognition tool is further configured to match the plurality of concepts against the list of terms and to recognize concepts and generate annotations.

In some embodiments, as shown in FIG. 2, the data set may be received as input to a concept recognition tool along with a dictionary. The dictionary (or lexicon) may include a list of strings that identify ontology concepts. The dictionary may be constructed by pooling concept names and other lexical identifiers, such as synonyms or alternative labels that identify concepts. In some embodiments, for example, the concept recognizer may implement a tree-based data-structure that enables fast and efficient matching of text against a set of dictionary terms to recognize concepts and generate direct annotations. The ontology structure may then create additional annotations. In some embodiments, the ontology-mapping component creates additional annotations based on existing mappings between ontology terms. The direct annotations and the set of semantically expanded annotations may then be scored and returned to the user, or passed on to the data mining engine, for example.

As shown in FIGS. 1 and 2, the ontology is configured to structure the plurality of concepts by annotating relationships between the concepts and creating aggregations of the concepts. An ontology can be defined as a rigorous and exhaustive organization of a knowledge domain that is usually hierarchical and contains relevant entities and their relations. An ontology may be a formal representation of the knowledge by a set of concepts within a domain and relationships between those concepts. It may be used to reason about the properties of that domain.

In some embodiments, the ontology is the Systematized Nomenclature of Medicine (SNOMED). SNOMED is a systematically organized computer processable collection of medical terminology covering most areas of clinical information such as diseases, findings, procedures, microorganisms, substances, etc. It allows a consistent way to index, store, retrieve, and aggregate clinical data across specialties and sites of care. Conventional systems may use only 4-5 codes, such as billing level, low granularity codes. These codes may be collected using traditional manual processes, thus mapping the data to ICD-9, for example, a billing lexicon. In the systems and methods described herein, SNOMED may provide a for more relevant and granular coding. For example, SNOMED may provide 40-50 highly granular codes per encounter note as compared to the 4-5 low granularity, billing level codes collected using traditional manual processes. SNOMED may allow the systems and methods described herein to utilize the full breadth of clinical charts and to inform better and more relevant care.

In some embodiments, the ontology may include terminologies, or controlled vocabularies (CVs). A CV provides a list of concepts and text descriptions of their meaning and a list of lexical terms corresponding to each concept. Concepts in a CV are often organized in a hierarchy. Thus, CVs provide a collection of terms that can structure the plurality of concepts by annotating relationships between the concepts and creating aggregations of the concepts. In some embodiments, the ontology may include information models (or data models). An information model provides an organizing structure to information pertaining to a domain of interest, such as microarray data, and describes how different parts of the information at hand, such as the experimental condition and sample description, relate to each other.

In some embodiments, an ontology can provide a single identifier (the class or term identifier) for describing each entity and can store alternative names for that entity through the appropriate metadata. The ontology can thus be used as a controlled terminology to describe biomedical entities in terms of their functions, disease involvement, etc, in a consistent way. In addition, in some embodiments, the ontology can be augmented with terminological knowledge such as synonymy, abbreviations and acronyms.

In some embodiments, the ontology may represent the data set itself, to provide an explicit specification of the terms used to express the biomedical information, such as the historical patient information. An ontology may make explicit the relationships among data types in databases, enabling applications to deduce subsumption among classes.

In some embodiments an ontology may provide lexicons to recognize named entities or concepts in text. Alternatively, ontologies may guide the NLP engine by providing knowledge models and templates for capturing facts from text. In some embodiments, an ontology may make inferences based on the knowledge the ontology contains as well as any additional contextual information or asserted facts.

These systems and methods may help researchers think about what information means in the context of what is already known. In some embodiments, an ontology may also provide knowledge for inference in decision support applications. Decision support applications may inform practitioners on the preferred practice or optimal decision given the specific contexts. For example, the system may help physicians to manage patients and recommend guideline-concordant choices of therapy.

In some embodiments, as shown in FIG. 2, the ontology is configured to structure the data set by aggregating features derived by the concept recognizer. Alternatively, in some embodiments, when the concept recognition tool is further configured to match the plurality of concepts against the list of terms and to recognize concepts and generate annotations, the ontology is further configured to create additional annotations.

An annotation may be the functional description of experimental data. Functional annotation may be seen more generally as a “normalization” process applied to datasets, enabling further processing. Related to the notion of indexing is that of term recognition, i.e., the process of automatically identifying mentions of entities of interest in text through natural language processing (NLP) techniques.

In some embodiments, once entities have been identified in text fragments, relationships among those entities may be identified and such relations may be explicitly represented in biomedical ontologies. In some embodiments, the use of ontologies to support relation extraction may include identifying not only entities in the data set or text, but also potential relationships. In some embodiment, clues for identifying relationships include lexical items (e.g., the preposition “on” for the relationship “located on”) and syntactic structures (e.g., “intracranial tumors including meningiomas” for “meningiomas is a intracranial tumors”), as well as statistical and pattern based clues.

As an example, consider the text: “Melanoma is a common tumor very frequent in skin and in the bowel.” In some embodiments, the system may generate the following annotations:
Melanoma [matching term: Melanoma (preferred name), position: 1-8] {10}
Common_Neoplasm [matching term: common tumor (synonym), position: 15-26] {8};
Frequently [matching term: frequent (synonym), position: 33-40] {8};
Skin [matching term: skin (preferred name), position: 45-48] {10};
Intestine [matching term: bowel (synonym), position: 61-65] {8};
   The “is a expansion” (limited to level 1) generates the annotations:
Common_Neoplasm [expanded from Melanoma, level:1] {9};
Melanocytic_Neoplasm [expanded from Melanoma, level:1] {9};
Organ [expanded from Skin, level:1] {9};
Organ [expanded from Intestine, level:1] {9};
   The user will finally get the following aggregated annotations, sorted by score:
Organ {9+9=18}
Common_Neoplasm {8+9=17}
Melanoma {10}
Skin {10}
Melanocytic_Neoplasm {9}
Frequently {8}
Intestine {8}

We can see in this example that the system finds the appropriate concepts in the given sentence and the scoring process ranks them (e.g. {9}) to reflect their importance. The “is a expansion” introduces parent level terms.

As shown in FIGS. 1 and 2, the data mining engine is configured to process the relationships between the plurality of concepts and the aggregations of the plurality of concepts and to identify associations and correlations in the data set. In some embodiments, as shown in FIG. 2, a data mining engine is configured to process the list of features derived by the concept recognizer to identify associations and correlations in the data set. Data mining can be defined as data processing using sophisticated data search capabilities and statistical algorithms to discover patterns and correlations in large databases or data sets, for example electronic medical record databases. Data mining may be used to discover new meaning in the data. In some embodiments, the data mining engine is the component that “learns” the associations. For example, based on the data set for a plurality of patients, the data mining engine may determine that for people diagnosed with disease XYZ, they may need treatment ABC in 85% of the cases.

In some embodiments, the data mining engine is further configured to build a predictive model from the data set. In some embodiments, the data mining engine is further configured to summarize large patient cohorts from the list of features. In some embodiments, the data mining engine is further configured to cluster data with respect to an outcome and identify paths through the list of features that lead to that outcome.

In general, predictive data mining may be concerned with analyzing data sets that are composed of data instances (e.g., cases or list of observations), where each instance is characterized by a number of attributes (also referred to as predictors, features, factors, or explanatory variables). There is a special additional attribute called an outcome variable, also referred to as a class dependent or response variable. In general, the task of predictive data mining may be to find the best fitting model that relates attributes to the outcome. Unlike standard data mining data sets, medical data sets may be smaller: typically, the number of instances is from several tens to several thousands. The number of attributes may widely range from several tens (classical problems from clinical medicine) to thousands (proteomics, genomics). In general, the goal of predictive data mining in clinical medicine is to construct a predictive model that is sound; makes reliable predictions; and helps physicians improve their prognosis, diagnosis, or treatment planning procedures. More specifically, predictive data mining in clinical medicine may be used to derive models that use patient specific information to predict the outcome of interest and to thereby support clinical decision-making. In general, predictive data mining methods may be applied to the construction of decision models for procedures such as prognosis, diagnosis and treatment planning, which—once evaluated and verified—may be embedded within clinical information systems.

In some embodiments, the data mining engine may be utilized for machine learning. Machine learning may be defined as the process by which computers are directed to improve their performance over time or based on previous results.

Returning to FIG. 2, the interface is configured to receive queries about the data set and to return corresponding associations and correlations identified in the data set. In some embodiments, the interface may be configured to interact with other tools or engines (for example, electronic medical record systems) to access the system and ask queries. In some embodiments, when the data mining engine is further configured to build a predictive model from the data set, the interface may be further configured to receive queries about the data set and to return information determined by the predictive model.

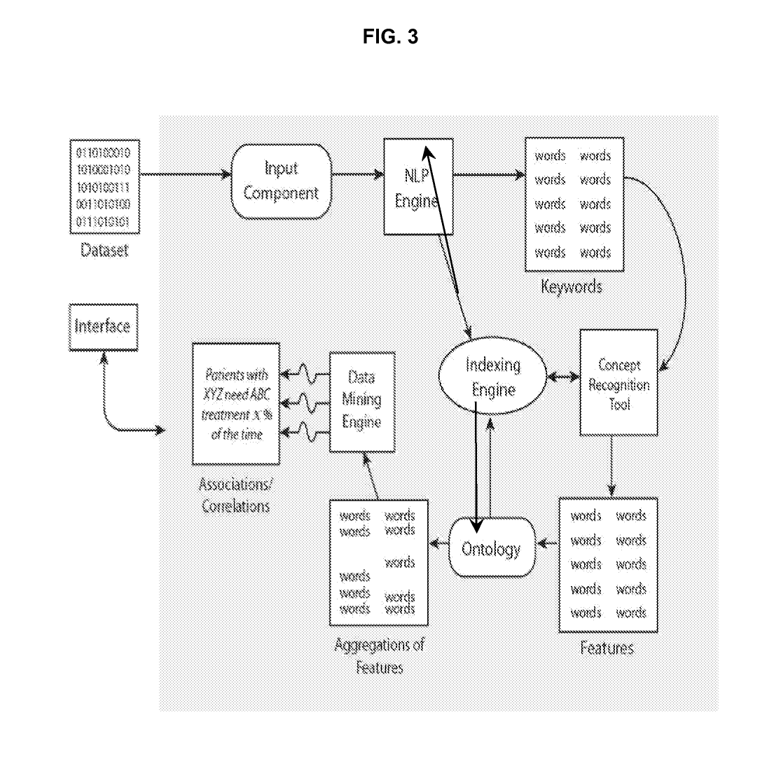

In some embodiments, as shown in FIG. 3, a system for processing patient history data may further include an input component configured to read in a data set from a database. In some embodiments, the input component may be a wrapper. A wrapper may be a program or script configured to prepare for and make possible the running of the remaining components of the system, i.e. the NLP engine, the ontology, etc. In some embodiments, the wrapper may include data that is put in front of or around a transmission (i.e. the transmission of the data set) and provides information about the data set. Alternatively, in some embodiments, the input component may be a data adaptor or input module. In some embodiments, the input component is configured to read in a data set from a database such as a hospital database or electronic medical records database, for example.

In some embodiments, as shown in FIG. 3, a system for processing patient history data may further include an indexing engine configured to search the data set. One example of an indexing engine is LUCENE. LUCENE is a high-performance, full-featured text search engine library written in Java. It is a technology suitable for nearly any application that requires full-text search, especially cross-platform. Any other suitable indexing or search engine may alternatively be utilized to search and/or index the data set.

In some embodiments, a system for processing patient data may further include a post processing engine. The post processing engine may be configured to transform output from an NLP engine into postcoordinated concepts. A postcoordinated concept may be one that includes a combination of multiple concepts. For example, the concepts of “left upper lobe”, “lung”, and “cancer”, may be merged by a post processing engine (i.e. during a post-coordinating step) to become a single code for “left upper lobe lung cancer”. In some embodiments, the post processing engine may be a terminology services engine, or it may be integrated with a terminology services engine. In some embodiments, a terminology services engine may comprise a database of concepts. A terminology services engine may provide appropriate concept combinations, thus creating postcoordinated concepts. In some embodiments, a terminology services engine may version track concepts.

In some embodiments, the post processing engine may convert output from a NLP engine to a specific data format. In some embodiments, the structured data output from the NLP engine may be formatted in one of a Clinical Document Architecture (CDA), a Continuity of Care Record (CCR), and a Continuity of Care Document (CCD) format. In one example, the NLP engine may output an output schema based on a data structure (e.g. CDA) specification. The output schema may be extended to accommodate additional (rich) context embedded appropriately. In this example, a terminology services engine may transform the output schema. The transform may include post-coordination of terms or concepts to a final granular code and all codes necessary to be in compliance with the given format (e,g, CDA).

FIGS. 1-3 illustrate exemplary embodiments of systems and methods for processing data. As shown in FIG. 1, in some embodiments, a method for processing data includes the steps of receiving a data set, scanning the data set with a natural language processing (NLP) engine to identify a plurality of concepts within a plurality of distinct contexts, structuring the data set with an ontology by creating aggregations of the concepts and annotating relationships between the concepts, identifying patterns in the relationships between the plurality of concepts. In some embodiments, the method may further include the step of storing the concepts, relationships, and aggregations as a digital representation of the patient. In some embodiments, a method for processing patient history data may include the steps of receiving a plurality of historical charts for a patient, scanning the plurality of historical charts with a natural language processing (NLP) engine to identify a plurality of concepts within a plurality of distinct contexts, structuring the plurality of historical charts with an ontology by annotating relationships between the concepts and creating aggregations of the concepts, and transforming the plurality of historical charts for a patient into a digital representation of the patient that includes the concepts, relationships, and aggregations.

In some embodiments, the step of receiving a plurality of historical charts further includes receiving a plurality of historical charts for a population of patients.

In some embodiments, the step of transforming the plurality of historical charts for a patient into a digital representation of the patient further includes transforming the plurality of historical charts for a population of patients into a digital representation of the patient population.

In some embodiments, the method may further include the step of comparing the digital representations of a first patient to the digital representations of a second patient. In some embodiments, the digital representations may be compared through cohort analysis. A cohort may be defined generally as a group of subjects who have shared a particular experience during a particular time span. In some embodiments, a cohort may be a group of people, or patients, having approximately the same age. Alternatively, a cohort may be a group of people that share a specific patient outcome, a group of people that have received similar care prior to the specific patient outcome, a group of people that share a specific disease, and/or a group of people that share any other suitable quality or experience.

In some embodiments, a cohort may represent group of people that share a specific patient outcome or result. In this embodiment, differing cohorts may have received different care prior to the outcome. A cohort analysis may be performed in order to evaluate differential results based on differential intervention.

In some embodiments, a cohort may represent group of people that share a specific disease state. In this embodiment, differing cohorts may have different outcome based on the same or differing interventions. A cohort analysis may be performed in order to evaluate differential results within a disease state based on differential intervention.

In some embodiments, a cohort may represent group of people that have experienced hospital readmission or another specific undesirable outcome. In this embodiment, differing cohorts may have different outcomes based on the same or differing interventions. A cohort analysis may be performed in order to evaluate differential undesirable outcome results based on differential intervention.

In some embodiments, a cohort may represent group of people that have experienced an adverse event. In this embodiment, differing cohorts may have different outcomes based on medication or other intervention applied. A cohort analysis may be performed in order to evaluate differential adverse event rates based on differential intervention.

In some embodiments, a cohort may represent group of people that have experienced a specific payer response to billing. In this embodiment, differing cohorts may have different outcomes based on submission pattern. A cohort analysis may be performed in order to evaluate payer response based on differential submission pattern.

As shown in FIG. 2, in some embodiments, a method for processing patient history data may include the steps of receiving a data set and identifying a plurality of concepts within the data set with a natural language processing (NLP) engine, recognizing the plurality of concepts within a plurality of distinct contexts and deriving a list of features that represent the data set with a concept recognition tool, structuring the data set by aggregating features with an ontology, processing the list of features and identifying associations and correlations in the data set with a data mining engine, and receiving queries about the data set and to returning corresponding associations and correlations identified in the data set.

In some embodiments, recognizing the plurality of concepts further includes matching the plurality of concepts against a list of dictionary terms and recognizing concepts and generating annotations. In some embodiments, structuring the data set further includes creating additional annotations with the ontology. In some embodiments, the method further includes the step of scoring the annotations.

In some embodiments, the system may be built on top of de-identified clinical data. This system may then inform clinical guideline design, enable comparative effectiveness research and allow risk prediction for optimizing operational care delivery workflows.

In some embodiments, patient data may be extracted from a clinical data warehouse for the purpose of data-mining. For example, Electronic Medical Records (EMR) may be processed within a clinical data warehouse using concept recognition systems to derive a list of “features”—concepts from existing medical ontologies—that represent each sample (e.g. patient). A concept recognition tool, described in more detail above, may be used to process clinical notes to create a “feature vector” including concept codes derived from a medical ontology such as SNOMEDCT, RXNORM, or any other suitable ontology or medical ontology. The final data set may contain a record identifier that may link or group multiple notes from the same individual.

In one exemplary embodiment, the features in a given sample may include “31019812 cholecystitis” and “30110261 likely”. In this example, an annotation sample may look like this:

| | | | |
|---|---|---|---|
| 31019812 | 1971 | 1982 | 22153 |
| 31019812 | 2158 | 2169 | 22153 |
| 31019812 | 2338 | 2349 | 22153 |
| 30110261 | 2279 | 2290 | 22153 |

In this example, the annotation sample may be interpreted as meaning that the term “cholecystitis” (31019812) was found in record number 22153 three (3) times. The term appears between character positions from 1971 to 1982, from 2158 to 2169, and from 2338 to 2349. The term “likely” (30110261) appears one (1) time in the same record between positions 2279 to 2290. The feature vector in this example may look like this: 22153 31019812 30110261. In some embodiments, various methods for arriving at the feature vectors may be used. For example, when applying negation detection, a “positive” as well as a “negative” vector may be created for each record which will then be analyzed accordingly. The positional information (e.g. character positions from 1971 to 1982) may be noted during annotation in order to aid in creating a “positive” as well as a “negative” vector.

These features may then be aggregated using ontology hierarchies to make the known dependencies between features explicit. Once data is transformed in this manner, data-mining techniques such as Bayesian model learning, support vector machines, and/or frequent item set mining may be applied to the data for the purpose of building predictive models and classifiers. The data may be explored in terms of the extracted features to create visualizations that summarize large patient cohorts. The data may also be analyzed with respect to an outcome in order to identify archetypical “paths” through the feature space that lead to the desired outcome. Such information can be fed into the clinical guideline design process especially for conditions for which published evidence is scarce. If long chains of temporally ordered features are available for a large enough cohort, then hidden markov models may be trained that can predict the next feature in the chain along with the likelihood of occurrence of that feature.

In this example, the system may include a concept recognizer, a set of scripts, and a dictionary that either can be installed on dedicated hardware, such as Linux hardware, or can be provided as a fully self-contained, virtual piece of hardware, such as a Virtual Machine image. The system may return concepts recognized in the clinical note, which may comprise the “annotations.” As shown in the example above, the annotations record the recognized terms (e.g. 31019812 for “cholecystitis”), the note id (e.g. 22153), as well as the position of the recognized term within the text (e.g. 1971 1982 indicating character positions from 1971 to 1982). In this embodiment, tabular data may be extracted directly from the clinical database such that a patient's electronic medical record can be roughly traced through time from one visit to the next. In some embodiments, notes data may be processed using a Chinese firewall approach to strictly protect patient privacy. In some embodiments, a piece of hardware may be specifically configured to annotate each note while sitting inside the firewall and it may only be operated by personnel authorized to access patient records for this designated purpose. The system may, for every note, scan through the text and output an “annotation record,” which is a piece of text including the annotations, and usually not the notes themselves.

Annotations derived from the data set, e.g. the notes data may be packaged with the tabular data and it may be tied directly to a note via the “visit note” identifier (a combination of patient, visit and note identifiers). In some embodiments, the final packaged data is considered sufficiently de-identified to be allowed outside the firewall. For example, for patient #4792, visit #6, and note #3, an annotation record linked to that specific patient's visit note may be stored. Each batch may be output to a file (or set of files) that may be stored, compressed, and delivered as a package with the clinical notes.

Various embodiments of systems and methods for processing unstructured data are provided herein. Although much of the description and accompanying figures generally focuses on systems and methods that may be utilized with electronic medical records including patient history data, in alternative embodiments, systems and methods of the present invention may be used in any of a number of systems and methods.

The examples and illustrations included herein show, by way of illustration and not of limitation, specific embodiments in which the subject matter may be practiced. Other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method for processing data, the method comprising:
receiving a data set;
scanning the data set using a natural language processing (NLP) engine to identify a plurality of concepts within a plurality of distinct contexts;
structuring the data set with an ontology by creating aggregations of the concepts and annotating relationships between the concepts; and
identifying patterns in the relationships between the plurality of concepts.

2. The method of claim 1, further comprising the step of storing the concepts, relationships, and aggregations as a digital representation of a patient.

3. The method of claim 1, wherein the plurality of concepts include noun phrases recognized by the NLP engine.

4. The method of claim 1, wherein the plurality of distinct contexts include medical contexts.

5. The method of claim 1, wherein receiving a data set comprises receiving at least one physician encounter note.

6. The method of claim 1, wherein scanning the data set further comprises using concepts in the data set to transform the data set into a plurality of concepts within a plurality of distinct contexts.

7. The method of claim 1, wherein scanning the data set further comprises employing an algorithm to scan the data set and to apply syntactic and semantic rules to the data set to transform the data set into a plurality of concepts within a plurality of distinct contexts.

8. A method for processing patient history data, the method comprising:
receiving a plurality of historical charts for a patient;
scanning the plurality of historical charts using a natural language processing (NLP) engine to identify a plurality of concepts within a plurality of distinct contexts;
structuring the plurality of historical charts with an ontology by annotating relationships between the concepts and creating aggregations of the concepts; and
transforming the plurality of historical charts for a patient into a digital representation of the patient that includes the concepts, relationships, and aggregations.

9. The method of claim 8, wherein the step of receiving a plurality of historical charts further comprises receiving a plurality of historical charts for a population of patients.

10. The method of claim 9, wherein the step of transforming the plurality of historical charts for a patient into the digital representation of the patient further comprises transforming the plurality of historical charts for a population of patients into a digital representation of the patient population.

11. The method of claim 10, further comprising the step of comparing digital representations of a first patient to digital representations of a second patient.

12. The method of claim 11, wherein comparing the digital representations of the first and second patients further comprises comparing the digital representations through a cohort analysis.

13. The method of claim 11, wherein comparing the digital representations further comprises comparing digital representations of a first plurality of patients to digital representations of a second plurality of patients.

14. A method for processing patient history data, the method comprising:
receiving a data set and identifying a plurality of concepts within the data set using a natural language processing (NLP) engine;
recognizing the plurality of concepts within a plurality of distinct contexts and deriving a list of features that represent the data not with a concept recognition tool;
structuring the data set by aggregating features with an ontology;
processing the list of features and identifying associations and correlations in the data set with a data mining engine; and
receiving queries about the data set and to returning corresponding associations and correlations identified in the data set.

15. The method of claim 14, wherein recognizing the plurality of concepts further comprises matching the plurality of concepts against a list of dictionary terms and recognizing concepts and generating annotations.

16. The method of claim 15, wherein structuring the data set further comprises creating additional annotations using the ontology.

17. The method of claim 16, further comprising a step of scoring the annotations.

18. The method of claim 14, wherein processing the list of features further comprises building a predictive model from the data set.

19. The method of claim 18, wherein returning corresponding associations and correlations identified in the data set further comprises returning information determined by the predictive model.

20. The method of claim 14, wherein processing the list of features further comprises summarizing large patient cohorts from the list of features.

21. The method of claim 14, wherein processing the list of features further comprises clustering data with respect to an outcome and identifying paths through the list of features that lead to that outcome.

22. The method of claim 14, further comprising storing the list of features as a digital representation of a patient.

23. A method for processing patient history data, the method comprising:
receiving a data set with an input component;
identifying a plurality of concepts within the data set using a natural language processing (NLP) engine;
recognizing the plurality of concepts within a plurality of distinct contexts and deriving a list of features that represent the data set using a concept recognition tool;
searching the plurality of concepts using an indexing engine;
structuring the data set by aggregating features using an ontology;
processing the list of features and identifying associations and correlations in the data set using a data mining engine; and
receiving queries about the data set and to returning corresponding associations and correlations identified in the data set.

24-39. (canceled)

40. The method of claim 23, further comprising a step of generating an output of an annotation record.

41. The method of claim 40 further comprising storing or displaying the output of the annotation record.
